(19) United States
(12) Patent Application Publication
(10) Pub. No.: US 2011/0048658 A1
(43) Pub. Date: Mar. 3, 2011

(54) CARGO SHADE FOR AUTOMOTIVE VEHICLE

(75) Inventors: Marc David Nedelman, Waterford, MI (US); Chi Li, Farmington Hills, MI (US)

(73) Assignee: FORD GLOBAL TECHNOLOGIES, LLC, Dearborn, MI (US)

(21) Appl. No.: 12/553,343

(22) Filed: Sep. 3, 2009

(51) Int. Cl. E06B 9/18

(52) U.S. Cl. 160/323.1

(57) ABSTRACT

A cargo shade for an automotive vehicle includes a shade storage device contained within a cargo area trim panel, and a retractable shade attached to the storage device. One end of the retractable shade is attached to a liftgate, such that opening the liftgate will cause the shade to be selectively elevated, to permit access to the cargo area without the necessity of retracting the shade.

### BACKGROUND OF THE INVENTION

1. Field of the Invention

The present invention relates to an accessory cargo shade for covering an interior load area of a vehicle, and more particularly to a cover for an interior load compartment of a sport utility vehicle.

2. Related Art

Drivers of sport utility vehicles often find it desirable to deploy a sight shield or “shade” extending over the load compartment or cargo area of their vehicles. Such shades are employed to prevent the viewing of items stored within the vehicle. Known cargo shades employ rollers which are usually mounted upon the quarter trim panels of the vehicle. Unfortunately, this mounting method has proven to be cumbersome, because in order to access the stowage area, the shade must be retracted, and this is an inconvenience. Moreover, storing the shade when the rear seat of the vehicle is folded down is a problem because it is quite lengthy and difficult to manage.

It would be desirable to provide a cargo shade which does not inhibit stowage of large articles within the rear cargo area of a vehicle, but which is readily moved out of the way by elevating a cargo area liftgate, even with the shade attached at both ends, while providing an integral roller and reducing the direct labor required to assemble a vehicle, as well as reducing the number of parts that need to be installed at the vehicle assembly plant or dealer.

### SUMMARY OF THE INVENTION

According to an aspect of the present invention, a cargo shade for an automotive vehicle includes a shade storage device contained within a cargo area trim panel. A retractable shade is attached to the storage device. According to an another aspect of the present invention, the cargo area trim panel containing the shade storage device may be attached, or integrated within, a liftgate or alternatively, a seatback. In the event that the cargo area trim panel is part of a liftgate, a flexible shade will be removably attached to a seatback at the front of the cargo compartment, as well as to the storage device. According to another aspect of the present invention, when the cargo area trim panel housing the shade storage device is attached to a seatback, the flexible shade can be removably attached to a liftgate cargo area closure, as well as to the storage device.

According to another aspect of the present invention, a storage device may include a roller journaled within a compartment which is integral with a cargo area trim panel. As before, the cargo area trim panel may either be a trim panel attached to a liftgate, or a trim panel attached to a seatback, both of which adjoin the rear cargo area of a vehicle.

It is an advantage of a cargo shade according to the present invention that the shade need not be retracted in order to access a stowage area within the vehicle.

It is another advantage of a cargo shade according to the present invention that storage of the shade is facilitated because the shade storage device, illustrated as a roller, is built into the vehicle and is carried within either a trim panel attached to a seatback, or a trim panel of a liftgate.

It is yet another advantage of a cargo shade according to the present invention that assembly labor and material cost is reduced, by reducing the number of parts needed to assemble a vehicle.

Other advantages, as well as features of the present system, will become apparent to the reader of this specification.

### BRIEF DESCRIPTION OF THE DRAWINGS

FIG. 1 is a perspective view of a vehicle having a cargo shade according to an aspect of the present invention.

FIG. 2 is a second perspective view of the cargo shade depicted in FIG. 1, but showing a liftgate in the closed position, as opposed to the open position shown in FIG. 1.

FIG. 3 illustrates a cargo shade according to an aspect of the present invention being installed within a seatback, as opposed to the liftgate installations shown in FIGS. 1 and 2.

FIG. 4 illustrates a cargo shade according to the present invention being installed within a liftgate and selectively attachable to a vehicle's quarter trim panels.

### DETAILED DESCRIPTION OF THE PREFERRED EMBODIMENTS

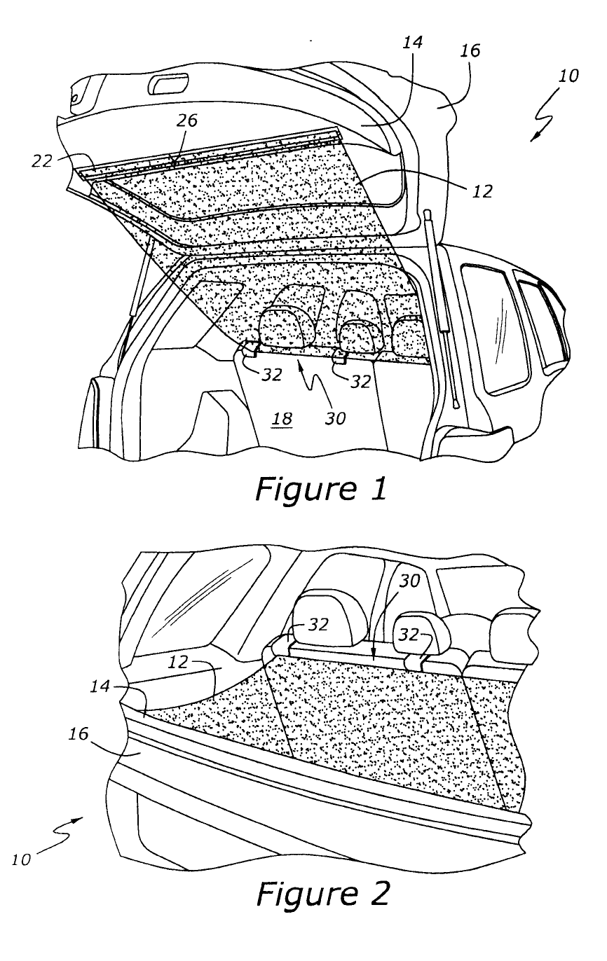

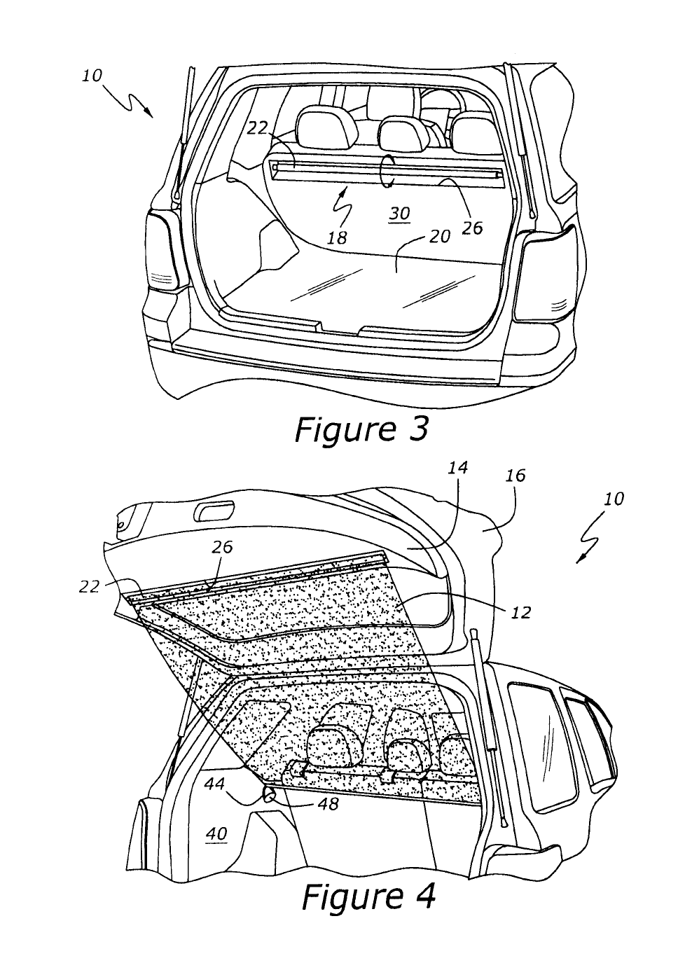

As shown in FIGS. 1 and 2, a vehicle, 10, is equipped with a flexible retractable shade, 12, which is wound upon a storage device embodied here as a roller, 22, which is shown in alternate locations in FIGS. 1 and 3. Shade 12 may be located upon roller 22 which is journaled within either liftgate trim panel 14, which is applied to the interior of liftgate 16, or alternatively, within a seatback trim panel, 30, which is applied to a rearward portion of seatback 18. In either event, roller 22 is contained, or journaled, within a recessed compartment, 26, which is set into a trim panel.

As is easily seen from the various Figures, liftgate 16 and seatback 18 adjoin cargo area 20 of vehicle 10 and define the front and rearmost portions of cargo area 20. When liftgate 16 is in its open position (FIG. 1), shade 12 is raised at its trailing end, allowing easy access to cargo compartment 20. Conversely, when liftgate 16 is closed (FIG. 2), visual access to cargo compartment 20 is prevented. Those skilled in the art will appreciate in view of this disclosure that shade 12 may be constructed from a range of woven, non-woven, composite, or non-composite materials having various optical densities.

When shade 12 is mounted within liftgate trim panel 14, shade 12 is selectively fastenable to seatback 18 by hook-and-loop fastenings 32, which are manually manipulated to fasten shade 12 to seatback trim panel 30. These fastenings are shown in FIGS. 1 and 2. In the embodiment of FIGS. 1 and 2, deployment of shade 12 involves manually withdrawing shade 12 from recessed compartment 26 (FIG. 1), followed by manually attaching shade 12 by means of hook-and-loop fasteners 32 either to seatback trim panel 30. In the embodiment shown in FIG. 3, to similar fastening provisions are provided upon liftgate trim panel 14. In either event, when liftgate 16 is placed in a raised position as shown in FIG. 1, shade 12 will be raised as also shown in FIG. 1, to allow access to the cargo area 20. Moreover, when shade 12 is arranged as shown in FIG. 3, that is, mounted upon roller 22 contained within seatback 18, and with the shade attached to liftgate trim panel 14, raising of liftgate 16 will also cause shade 12 to be lifted to allow access to cargo area 20.

FIG. 4 shows an embodiment in which cargo shade 12 is selectively attachable to interior quarter trim panels, 40, (one being shown). A loop, 44, mounted upon shade 12, is engageable with mushroom-shaped posts, 48, (one shown) mounted to panels 40 at each side of shade 12.

The foregoing invention has been described in accordance with the relevant legal standards, thus the description is exemplary rather than limiting in nature. Variations and modifications to the disclosed embodiment may become apparent to those skilled in the art and fall within the scope of the invention. Accordingly the scope of legal protection afforded this invention can only be determined by studying the following claims.

What is claimed is:

1. A cargo shade for an automotive vehicle, comprising:
a shade storage device contained within a cargo area trim panel; and
a retractable cargo area shade attached to said storage device.

2. A cargo shade according to claim 1, wherein said cargo area trim panel is attached to a liftgate.

3. A cargo shade according to claim 1, wherein said cargo area trim panel is attached to a seat back.

4. A cargo shade according to claim 1, wherein said cargo area trim panel is attached to a liftgate, with said flexible shade being selectively attachable to a seatback, as well as to said storage device.

5. A cargo shade according to claim 1, wherein said cargo area trim panel is attached to a seat back, with said flexible shade being selectively attachable to a liftgate partially enclosing the cargo area, as well as to said storage device.

6. A cargo shade according to claim 1, wherein said storage device comprises a roller journaled within a compartment which is integral with said cargo area trim panel.

7. A cargo shade according to claim 1, wherein said storage device comprises a roller journaled within a compartment which is integral with a trim panel attached to an interior side of a liftgate enclosing a portion of said cargo area.

8. A cargo shade according to claim 1, wherein said storage device comprises a roller.

9. A cargo shade according to claim 1, wherein said storage device comprises a roller journaled within a compartment which is integral with a trim panel attached to a seat back.

10. A cargo shade according to claim 1, wherein said cargo area trim panel is attached to a liftgate, with said flexible shade being selectively attachable to quarter trim panels, as well as to said storage device.

11. A cargo shade for an automotive vehicle, comprising:
a shade storage roller journaled within a cargo area trim panel attached to a seat back; and
a flexible, retractable shade having a first end attached to said storage roller and a second end which is selectively attachable to a liftgate enclosing a portion of said cargo area, whereby said second end of said cargo shade will be selectively elevated when said liftgate is opened, to permit access to said cargo area.

12. A cargo shade according to claim 11, wherein said seat back and said trim panel enclose a portion of said cargo area.

13. A cargo shade according to claim 11, wherein said second end of said flexible shade is removably attached to said liftgate.

14. A cargo shade for an automotive vehicle, comprising:
a shade storage roller journaled within a liftgate trim panel; and
a flexible, rectractable shade having a first end attached to said storage roller and a second end which is selectively attachable to a portion of a seat adjoining said cargo area, whereby said first end of said cargo shade may selectively be elevated when said liftgate is opened, to permit access to said cargo area.

15. A cargo shade according to claim 14, wherein said liftgate encloses a portion of said cargo area.

16. A cargo shade according to claim 14, wherein said second end of said flexible shade is removably attached to said seat portion.
